(19) United States
(12) Patent Application Publication
(10) Pub. No.: US 2016/0013998 A1
(43) Pub. Date: Jan. 14, 2016

(54) Collecting ad Uploading Data from Marine Electronics Device

(71) Applicant: Navico Holding AS, Egersund (NO)

(72) Inventors: Shane Coloney, Jenks, OK (US); Tom Isaacson, Auckland (NZ); Phillip King Gaynor, Pocasset, MA (US)

(21) Appl. No.: 14/625,990

(22) Filed: Feb. 19, 2015

Related U.S. Application Data
(60) Provisional application No. 62/040,767, filed on Aug. 22, 2014.
(60) Provisional application No. 62/022,064, filed on Jul. 8, 2014.

(51) Int. Cl. H04L 12/26; H04L 12/24; G01S 19/01; H04L 12/911; G01S 13/02; G01S 15/02

(52) U.S. Cl. CPC H04L 43/065; G01S 13/02; G01S 15/02; G01S 19/01; H04L 47/70; H04L 41/0816

(57) ABSTRACT

Various implementations described herein are directed to a non-transitory computer readable medium having stored thereon computer-executable instructions which, when executed by a computer, may cause the computer to collect data at a marine electronics device. The computer may determine whether a network connection exists to a cloud server. The computer may also, when the network connection exists, send the collected data to the cloud server.

### CROSS-REFERENCE TO RELATED APPLICATIONS

This application claims the benefit of U.S. Provisional Patent Application Ser. No. 62/022,064, filed Jul. 8, 2014, titled VARIOUS SOFTWARE FEATURES FOR MARINE ELECTRONICS DEVICE, and the disclosure of which is incorporated herein by reference.

This application claims the benefit of U.S. Provisional Patent Application Ser. No. 62/040,767, filed Aug. 22, 2014, titled VARIOUS SOFTWARE FEATURES FOR MARINE ELECTRONICS DEVICE, and the disclosure of which is also incorporated herein by reference

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Various forms of marine electronics data may be processed and/or displayed using a computing device disposed aboard a vessel. In one scenario, the computing device may include a multi-function display (MFD). Marine electronics data displayed using the computing device may be used to help navigate the vessel, and the data may include, for example, sonar data, chart data, radar data, or navigation data such as laylines.

### SUMMARY

Described herein are implementations of various technologies for a marine electronics device. The device includes one or more processors and a memory. The memory has a plurality of executable instructions. When the executable instructions are executed by the one or more processors, the processors may store data collected by the marine electronics device or data received from one or more peripheral devices in communication with the marine electronics device. The processors may determine whether a network connection exists between the marine electronics device and a cloud server. The processors may also, in response to a determination that the network connection exists, send the stored data to the cloud server.

Described herein are also implementations of various technologies for sending data to a cloud server. In one implementation, a non-transitory computer-readable medium having stored thereon computer-executable instructions which, when executed by a computer, cause the computer to perform various actions. The actions may include collecting data at a marine electronics device. The actions may include determining whether a network connection exists to a cloud server. The actions may also include, when the network connection exists, sending the collected data to the cloud server.

Described herein are also implementations of various technologies for sending data to a cloud server. In one implementation, a non-transitory computer-readable medium having stored thereon computer-executable instructions which, when executed by a computer, cause the computer to perform various actions. The actions may include receiving data at a marine electronics device from one or more peripheral devices in communication with the marine electronics device. The actions may include storing the received data on the marine electronics device. The actions may include determining whether a network connection exists to a cloud server. The actions may also include, when the network connection exists, sending the stored data to the cloud server.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a marine networking system in accordance with implementations of various techniques described herein.

FIG. 2 is a flow diagram of a method for uploading stored data to a cloud server in accordance with implementations of various techniques described herein.

FIG. 3 illustrates a schematic of a marine electronics device in accordance with implementations of various techniques described herein.

FIG. 4 illustrates a schematic diagram of a computing system in which the various technologies described herein may be incorporated and practiced.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the implementations described herein.

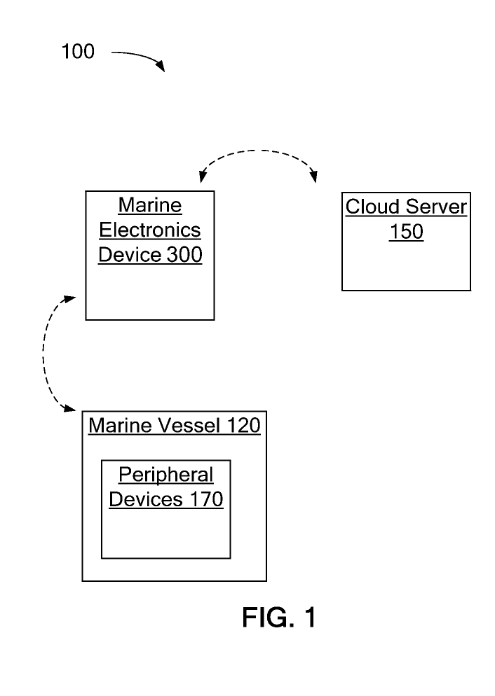

FIG. 1 illustrates a block diagram of a marine networking system 100 in accordance with implementations of various techniques described herein. The marine networking system 100 may include several components, such as a marine electronics device 300 (which may be a multi-function display or a chartplotter), a cloud server 150, a marine vessel 120, and peripheral devices 170 disposed on a marine vessel 120. The cloud server 150 may be a server located on the Internet, which may be operated by a vendor. A web browser may be included in the user interface of the marine electronics device 300. As such, a user may use the web browser to connect to the cloud server 150 over the Internet. The marine electronics device 300 may collect data from the marine networking system 100, as well as manage and control various navigation related systems and the peripheral devices 170 disposed onboard the marine vessel 120.

The peripheral devices 170 may include a sonar system, a Global Positioning System (GPS) device, such as a GPS receiver or a similar device such as GLONASS or global navigation satellite system (GNSS) receiver, a radar system, a propulsion system, various navigation systems, and any other systems, such as lighting systems, wireless data communication devices, wireless audio communications devices, audio and video entertainment devices, weather and environmental sensor systems, etc., disposed on the marine vessel 120. The marine electronics device 300 may be connected to the peripheral devices 170, and may communicate using a National Marine Electronics Association (NMEA) communication protocol or other mutually compatible protocol. For more information regarding the marine electronics device 300, see the section titled MARINE ELECTRONICS DEVICE below.

The marine electronics device 300 or the peripheral devices 170 may be associated with a user or user account. As such, a respective user may set up a user account with the cloud server 150. The respective user may register the marine electronics device 300, the marine vessel 120 or the peripheral devices 170 to the user account. The user account may be associated with security information (e.g., an account identification, an account password, etc.), a personal profile (e.g., customer identification, such as name, address, phone number, etc.), product information (e.g., product serial numbers, the type of marine electronics device 300, the type of the marine vessel 120, and other component information such as for a radar system or sonar system, etc.), and financial information (e.g., customer billing information, credit card information, purchase history, etc.). Account information may be stored on the cloud server 150. The respective user may access and modify information stored in the user account to verify accuracy. Security measures may be put in place to maintain the respective user's privacy and protect sensitive personally identifiable information.

In some implementations, the user account may be associated with an online profile, such as a profile that is visible to other users on a social networking site. Information in the user account may be synchronized or shared with information displayed in the online profile. The online profile may also be used to display information collected by the marine electronics device 300 or from the peripheral devices 170. As such, the marine electronics device 300 may manage information in the online profile by changing various settings (e.g., privacy settings regarding which users, such as social media friends, are able to access the online profile, or information settings regarding what information is collected or displayed with respect to the user, etc.) or information stored in the user account. The online profile may also be synchronized with one or more respective social networking sites, where a change to information in the online profile may change the information displayed in the respective social networking sites.

Collecting and Uploading Data from Marine Electronics Device to a Cloud Server

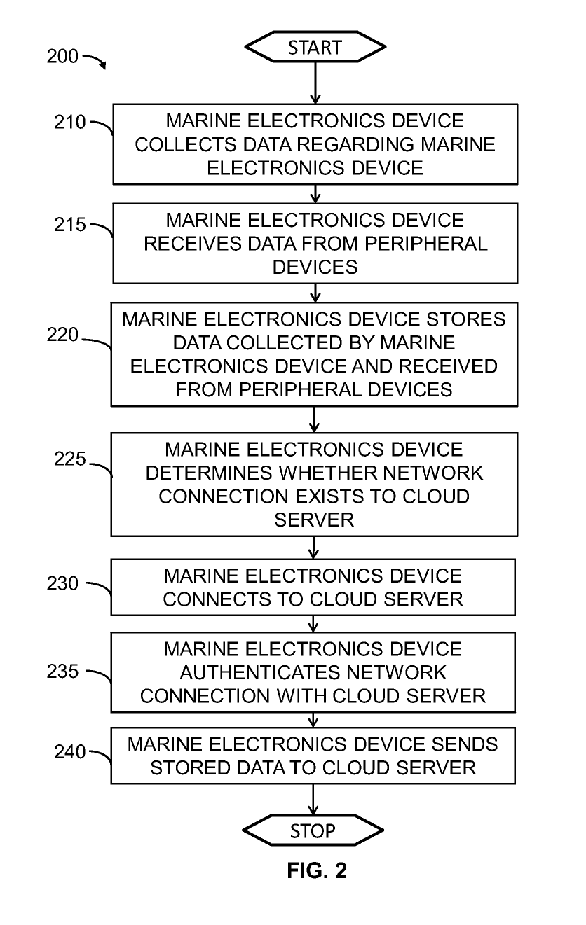

FIG. 2 illustrates a flow diagram for a method 200 for uploading stored data to the cloud server 150 in accordance with implementations of various techniques described herein. In one implementation, method 200 may be performed by the marine electronics device 300. It should be understood that while method 200 indicates a particular order of execution of operations, in some implementations, certain portions of the operations might be executed in a different order. Further, in some implementations, additional operations or steps may be added to the method 200. Likewise, some operations or steps may be omitted.

At block 210, the marine electronics device 300 may collect data regarding the marine electronics device 300 (i.e., “the collected data”). For instance, the collected data may describe which devices are connected to the marine electronics device 300, how the marine electronics device 300 was used (e.g., user interface history, how often a user changes pages, what user interface setup is preferred or most commonly used on the marine electronics device 400, web browser history, cookies, how often particular software features are selected by a user, etc.), and which problems a user previously experienced (e.g., crash history regarding one or more software applications operating on the marine electronics device 300), system performance history regarding one or more software and/or hardware components, and other data relating to the operation of the marine electronics device 300. This data gathering process at block 210 may be performed automatically by a software application operating in the background of the marine electronics device 300.

In one implementation, the collected data may describe one or more user activities monitored by the marine electronics device 300, such as data relating to fishing logs, trip logs, tournament/races and other activities engaged by a user of the marine electronics device 300. With fishing logs, for example, the marine electronics device 300 may collect data regarding a catch (e.g., the location of a catch, the time of the catch, the size of the fish caught, the type of fish caught, etc.). For trip logs, the marine electronics device 300 may collect data regarding the starting time and ending time of a trip, locations visited on the trip, navigation conditions during the trip, etc. With respect to tournament/races, the marine electronics device 300 may collect data regarding one or more particular races (e.g., how many participants competed in the race, how did the user finish in the race, such as first or second place, what is a user's current ranking in a tournament with multiple races, etc.).

At block 215, the marine electronics device 300 may receive data from the peripheral devices 170 (i.e., “the received data”). For instance, the data from the peripheral devices 170 may include telematics data, such as transmitted over the marine networking system 100. Telematics data may include network information obtained from any device or system which is capable of being measured or controlled through electronic means, such as analog or digital methods. Such devices or systems may include switch position and switch activation systems, electric power generation and supply systems (e.g., AC and DC systems), water management systems for supply and/or consumption, lighting systems, and security systems. The telematics data may also describe how these and other systems such as the sonar system, radar system, and other peripheral devices 170 have operated as well as the GPS location when various problems occurred with the marine vessel 120 or the peripheral devices 170. With respect to the engine on the marine vessel 120, telematics data may include information regarding measurements from sensors in the engine that record various operating conditions, such as the engine's performance, how long has the engine been operating, information on engine alarms, the results of engine diagnostic tests, etc.

Telematics data may also include data associated with a National Marine Electronics Association (NMEA) communication standard (e.g., NMEA 2000 or NMEA 0183). The NMEA communication standard may provide a protocol for communicating data acquired by sensors and marine instruments. The NMEA communication standard may also determine how display units or other devices on a ship receive and use the acquired data. For instance, the NMEA compliant devices may include auto pilots, wind instruments, water temperature gauges, depth sounders, and engine instruments.

In other implementations, the telematics data may include data regarding navigational and environmental conditions around the marine vessel 120. Using instruments disposed on the marine vessel 120, the marine electronics device 300 may receive air temperature data, water temperature data, weather information, wind data, heading data, bearing data, location data (e.g., GPS coordinates) regarding the marine vessel 120, sonar data, radar data, or any navigational or environmental data with respect to the marine vessel 120.

At block 220, the marine electronics device may store the data collected by the marine electronics device at block 210 or the data received from the peripheral devices 170 at block 215 (i.e., “the stored data”). The marine electronics device 300 may store the data in memory or hard disk on the marine electronics device 300, or to an external storage device. In one implementation, the stored data may be located in a database on the marine electronics device 300.

At block 225, the marine electronics device 300 may determine whether a network connection exists between the marine electronics device 300 and the cloud server 150. For instance, method 200 may determine whether the marine electronics device 300 has Internet access through a wireless connection or a wired connection, e.g., through an Ethernet connection. For a wireless connection, the marine electronics device 300 may search for a wireless access point, such as a nearby router, WiFi hotspot or cellular tower, which may be broadcasting proximate the marine electronics device 300. If no connection to the cloud server 150 is found, the marine electronics device 300 may periodically perform another check for a network connection. If a network connection exists, method 200 may proceed to block 230.

At block 230, the marine electronics device 300 may connect to the cloud server 150 over a network connection.

At block 235, the marine electronics device 300 may authenticate the network connection from block 230 with the cloud server 150 (also referred to as a “handshake”). To authenticate the network connection, the marine electronics device 300 may send security information (e.g., password information) to the cloud server 150 to verify that the marine electronics device 300 is associated with a particular user or user account. As such, the security information may correspond to information stored in a designated user account on the cloud server 150.

If the cloud server 150 verifies that the security information matches a designated user account, the cloud server 150 may create a secure connection with the marine electronics device 300. The secure connection may encrypt information that is sent between the cloud server 150 and the marine electronics device 300. Once a secure connection has been established, the cloud server 150 may provide the marine electronics device 300 with access to one or more features, e.g., uploading stored data to the cloud server 150 at block 240 below. At block 240, the marine electronics device 300 may send or upload the stored data from block 220 to the cloud server 150 over the network connection at block 230 (i.e., “the sent data” or “the offloaded data”). For instance, the marine electronics device 300 may store data at block 220 while the marine electronics device 300 lacks Internet access. Once a network connection to the cloud server 150 is established, the marine electronics device 300 may upload the stored data to the cloud server 150. Further, after offloading data, the marine electronics device 300 may delete the stored data. As such, method 200 may return to block 210 and/or block 215 to obtain new data collected by the marine electronics device 300 or new data received from the peripheral devices 170. The next data offload may include the new data that was stored at block 220 since the previous offload.

In one implementation, the marine electronics device 300 may send the stored data at a predetermined time designated for uploading data to the cloud server 150, e.g., once per day. In another implementation, a user may manually authorize a data offload to the cloud server 150. For instance, a user may select an icon in the user interface of the marine electronics device 300 that initiates a data offload to the cloud server. In another implementation, the stored data may be sent automatically upon connecting to the cloud server 150 at block 230 or after authenticating a network connection at block 235, respectively.

In some implementations, a user may take an affirmative action for opting-in to the data collection procedures described at blocks 210-240. In opting-in, the user may choose which types of data are stored by the marine electronics device 300 or sent to the cloud server 150. For instance, a dialog box on the marine electronics device 300 may provide notice to the user that personal or other types of data may be collected by the marine electronics device 300. The dialog box may then allow the user to consent or opt-out of having one or more types of data collected. The dialog box may explain how the stored data may be used as well as direct the user to information regarding various privacy policies. In other implementations, the user may take an affirmative action to opt-out or prevent various data collection procedures at blocks 210-240. After having been adequately informed of the data collection procedures of blocks 210-240 of the marine electronics device 300, the user may disable the data collection features.

In another implementation, the marine electronics device 300 may provide notifications asking a user how to use the stored data. For instance, when a program on the marine electronics device 300 crashes, the marine electronics device 400 may prompt a message to the user asking for permission to send data related to the crash to the cloud server 150. As such, the user may accept or reject the request. These notifications may be set in user preferences on the marine electronics device 300 or in a user account.

### Marine Electronics Device

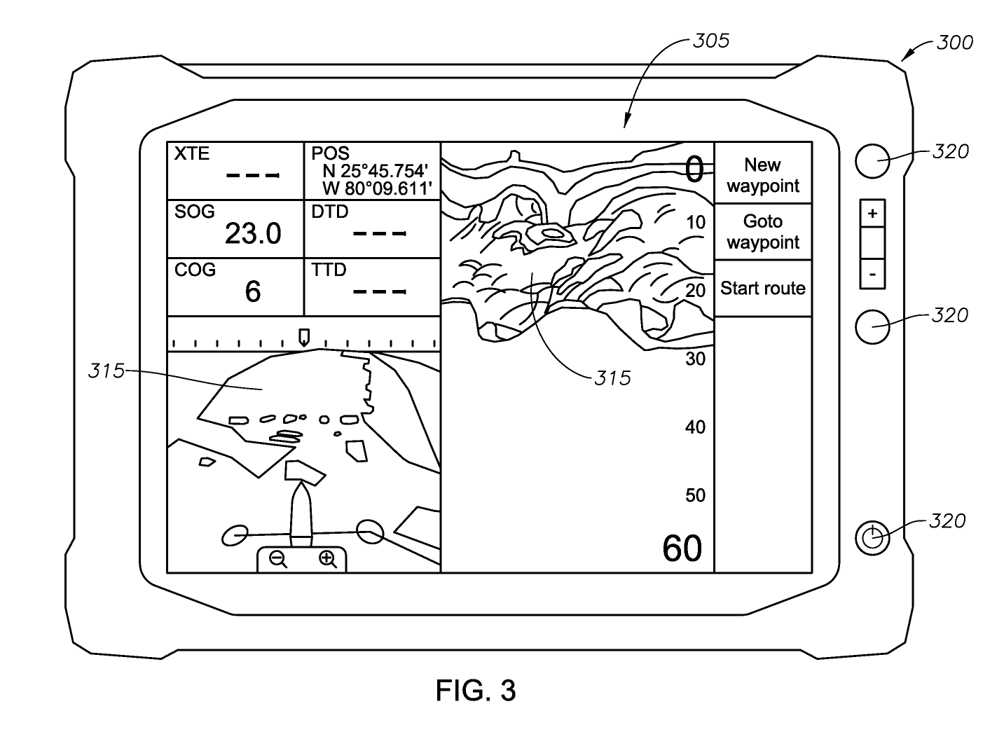

FIG. 3 illustrates a schematic diagram of a marine electronics device 300 in accordance with various implementations described herein. The components of the marine display device 300 are described in more detail with reference to the computing system 400 in FIG. 3. The marine electronics device 300 includes a screen 305. In certain implementations, the screen 305 may be sensitive to touching by a finger. In other implementations, the screen 305 may be sensitive to the body heat from the finger, a stylus, or responsive to a mouse. The display device 300 may display marine electronic data 315. The marine electronic data types 315 may include chart data, radar data, sonar data, steering data, dashboard data, navigation data, fishing statistics, vessel systems data, and the like. The marine electronics device 300 may also include a plurality of buttons 320, which may be either physical buttons or virtual buttons, or a combination thereof.

### Computing System

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computer, and the like.

Various technologies described herein may be implemented in the context of marine electronics, such as devices found in marine vessels and/or navigation systems. Ship instruments and equipment may be connected to the computing systems described herein for executing one or more navigation technologies. As such, the computing systems may be configured to operate using sonar, radar, the global positioning system (GPS), propulsion systems, and like technologies.

Various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

Various technologies described herein may be implemented in computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

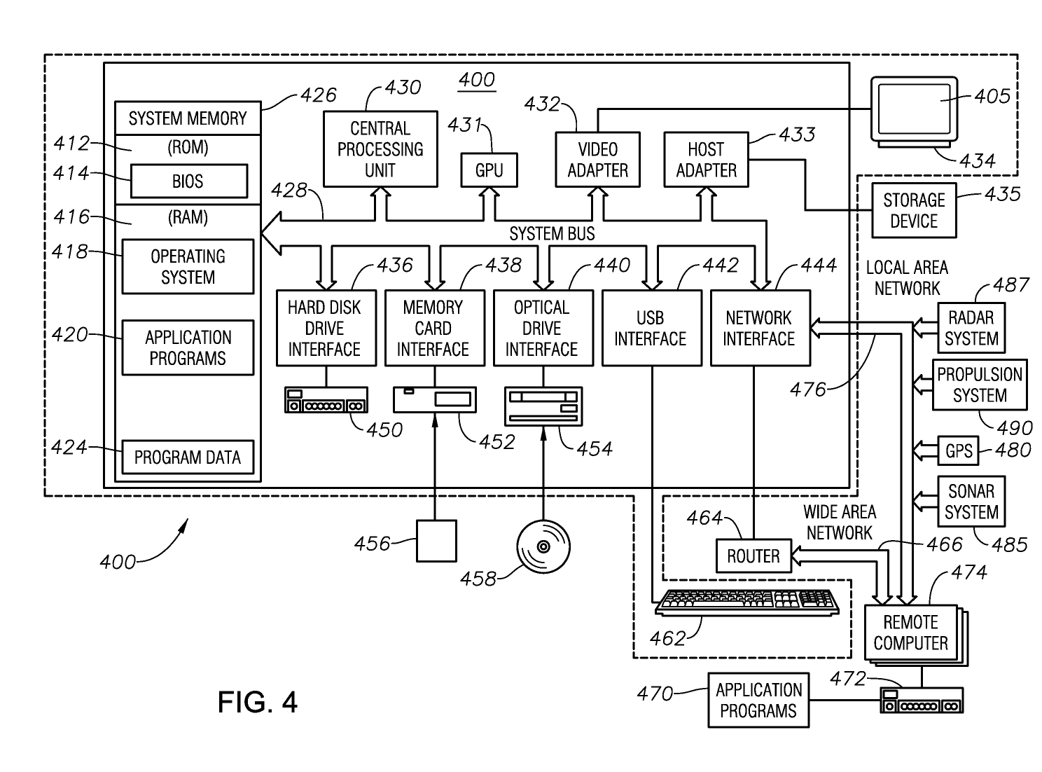

FIG. 4 illustrates a schematic diagram of the waypoint generation system 100 having a computing system 400 in accordance with implementations of various techniques described herein. The computing system 400 may be the marine electronics device 300, conventional desktop, a handheld device, a controller, a personal digital assistant, a server computer, an electronics device/instrument, a laptop, a tablet, or part of a navigation system, or sonar system. It should be noted, however, that other computer system configurations may be used.

The computing system 400 may include a central processing unit (CPU) 430, a system memory 426, a graphics processing unit (GPU) 431 and a system bus 428 that couples various system components including the system memory 426 to the CPU 430. Although only one CPU 430 is illustrated in FIG. 4, it should be understood that in some implementations the computing system 400 may include more than one CPU 430.

The CPU 430 can include a microprocessor, a microcontroller, a processor, a programmable integrated circuit, or a combination thereof. The CPU 430 can comprise an off-the-shelf processor such as a Reduced Instruction Set Computer (RISC), including an Advanced RISC Machine (ARM) processor, or a Microprocessor without Interlocked Pipeline Stages (MIPS) processor, or a combination thereof. The CPU 430 may also include a proprietary processor. The CPU 430 may include a multi-core processor.

The GPU 431 may be a microprocessor specifically designed to manipulate and implement computer graphics. The CPU 430 may offload work to the GPU 431. The GPU 431 may have its own graphics memory, and/or may have access to a portion of the system memory 426. As with the CPU 430, the GPU 431 may include one or more processing units, and each processing unit may include one or more cores.

The CPU 430 may provide output data to a GPU 431. The GPU 431 may generate graphical user interfaces that present the output data. The GPU 431 may also provide objects, such as menus, in the graphical user interface. A user may provide inputs by interacting with the objects. The GPU 431 may receive the inputs from interaction with the objects and provide the inputs to the CPU 430. A video adapter 432 may be provided to convert graphical data into signals for a monitor 434. The monitor 434 includes a screen 405. The screen 405 can be sensitive to heat or touching (now collectively referred to as a “touch screen”). In one implementation, the host computer 499 may not include a monitor 434. In one implementation, the CPU 430 may perform the tasks of the GPU.

The system bus 428 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral device Interconnect (PCI) bus also known as Mezzanine bus. The system memory 426 may include a read only memory (ROM) 412 and a random access memory (RAM) 416. A basic input/output system (BIOS) 414, containing the basic routines that help transfer information between elements within the computing system 400, such as during start-up, may be stored in the ROM 412.

Certain implementations may be configured to be connected to a global positioning system (GPS) 480, a sonar system 485, a radar system 487, and propulsion system 490. The GPS 480, the sonar system 485, the radar system 487, and/or the propulsion system 490 may be connected via the network interface 444. The computing system 400, the monitor 434, the screen 405, and buttons may be integrated into a console.

The computing system 400 may further include a hard disk drive interface 436 for reading from and writing to a hard disk 450, a memory card reader 452 for reading from and writing to a removable memory card 456, and an optical disk drive 454 for reading from and writing to a removable optical disk 458, such as a CD ROM or other optical media. The hard disk 450, the memory card reader 452, and the optical disk drive 454 may be connected to the system bus 428 by a hard disk drive interface 436, a memory card reader interface 438, and an optical drive interface 440, respectively. The drives and their associated computer-readable media may provide nonvolatile storage of computer-readable instructions, data structures, program modules and other data for the computing system 400.

Although the computing system 400 is described herein as having a hard disk, a removable memory card 456 and a removable optical disk 458, it should be appreciated by those skilled in the art that the computing system 400 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, including a Solid State Disk (SSD), CD-ROM, digital versatile disks (DVD), or other optical storage, magnetic cassettes, magnetic tape, magnetic disk storage or other magnetic storage devices, or any other medium which can be used to store the desired information and which can be accessed by the computing system 400. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 400 may also include a host adapter 433 that connects to a storage device 435 via a small computer system interface (SCSI) bus, a Fiber Channel bus, an eSATA bus, or using any other applicable computer bus interface. The computing system 400 can also be connected to a router 464 to establish a wide area network (WAN) 466 with one or more remote computers 474 (e.g., the cloud server 150). The router 464 may be connected to the system bus 428 via a network interface 444. The remote computers 474 can also include hard disks 472 that store application programs 470 (e.g., the mobile content store 190).

In another implementation, as discussed in more detail with respect to FIG. 2, the computing system 400 may also connect to one or more remote computers 474 via local area network (LAN) 476 or the WAN 466. When using a LAN networking environment, the computing system 400 may be connected to the LAN 476 through the network interface or adapter 444. The LAN 476 may be implemented via a wired connection or a wireless connection. The LAN 476 may be implemented using Wi-Fi technology, cellular technology, or any other implementation known to those skilled in the art. The network interface 444 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 474. It will be appreciated that the network connections shown are exemplary and other means of establishing a communications link between the computer systems may be used. The network interface 444 may also include digital cellular networks (e.g., GSM), Bluetooth, or any other wireless network interface.

A number of program modules may be stored on the hard disk 450, memory card 456, optical disk 458, ROM 412 or RAM 416, including an operating system 418, one or more application programs 420, and program data 424. In certain implementations, the hard disk 450 may store a database system. The database system could include, for example, recorded points. The application programs 420 may include various mobile applications (“apps”) and other applications configured to perform various methods and techniques described herein. The operating system 418 may be any suitable operating system that may control the operation of a networked personal or server computer.

A user may enter commands and information into the computing system 400 through input devices such as a keyboard 462 and pointing device. Other input devices may include a microphone, joystick, game pad, satellite dish, scanner, user input button, or the like. These and other input devices may be connected to the CPU 430 through a Universal Serial Bus (USB) interface 442 coupled to system bus 423, but may be connected by other interfaces, such as a parallel port, Bluetooth, or a game port. A monitor 405 or other type of display device may also be connected to system bus 428 via an interface, such as a video adapter 432 or a wireless interface. In addition to the monitor 434, the computing system 400 may further include other peripheral output devices such as speakers and printers.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A marine electronics device, comprising:
one or more processors;
memory having a plurality of executable instructions which, when executed by the one or more processors, cause the one or more processors to:
store data collected by the marine electronics device or data received from one or more peripheral devices in communication with the marine electronics device;
determine whether a network connection exists between the marine electronics device and a cloud server; and
in response to a determination that the network connection exists, send the stored data to the cloud server.

2. The marine electronics device of claim 1, wherein the executable instructions that cause the one or more processors to determine whether the network connection exists comprise executable instructions to determine whether the marine electronics device has Internet access.

3. The marine electronics device of claim 1, wherein the executable instructions that cause the one or more processors to determine whether the network connection exists comprise executable instructions to:
determine that a wireless access point is proximate to the marine electronics device; and
connect to the cloud server using the wireless access point.

4. The marine electronics device of claim 1, wherein the executable instructions that cause the one or more processors to connect to the cloud server comprise executable instructions to authenticate the network connection using information stored in a user account.

5. The marine electronics device of claim 1, wherein the one or more peripheral devices comprise:
a radar system;
a sonar system;
a propulsion system;
a global positioning system (GPS) device; or
a combination thereof.

6. The marine electronics device of claim 1, wherein the memory further comprises executable instructions that cause the one or more processors to control the operation of a marine vessel.

7. The marine electronics device of claim 1, wherein the data collected by the marine electronics device comprise:
user interface history for the marine electronics device;
web browser history for the marine electronics device;
crash history regarding one or more software applications operating on the marine electronics device;
system performance history regarding the marine electronics device; or
a combination thereof.

8. The marine electronics device of claim 1, wherein the data collected by the marine electronics device describes one or more user activities monitored by the marine electronics device.

9. The marine electronics device of claim 1, wherein the data received from the one or more peripheral devices comprise:
sonar data;
radar data;
water temperature data;
air temperature data;
location data regarding a marine vessel; or
a combination thereof.

10. The marine electronics device of claim 1, wherein the data received from the one or more peripheral devices comprise telematics data transmitted over a National Marine Electronics Association (NMEA) communication protocol.

11. The marine electronics device of claim 10, wherein the telematics data comprise measurements taken from at least one of the following:
one or more auto pilots;
one or more wind instruments;
one or more water temperature gauges;
one or more depth sounders;
one or more engine instruments;
or a combination thereof.

12. The marine electronics device of claim 1, wherein the memory further comprises executable instructions that cause the one or more processors to determine whether a user associated with the marine electronics device has granted permission to send the stored data to the cloud server, and wherein the stored data is sent to the cloud server in response to a determination that permission was granted.

13. A non-transitory computer-readable medium having stored thereon a plurality of computer-executable instructions which, when executed by a computer, cause the computer to:
collect data at a marine electronics device;
determine whether a network connection exists to a cloud server; and
when the network connection exists, send the collected data to the cloud server.

14. The non-transitory computer-readable medium of claim 13, wherein the computer-executable instructions that cause the computer to determine whether the network connection exists comprise computer-executable instructions which, when executed by the computer, cause the computer to determine whether a connection exists to the Internet.

15. The non-transitory computer-readable medium of claim 13, wherein the data collected at the marine electronics device comprise:
user interface history for the marine electronics device;
web browser history for the marine electronics device;
crash history regarding one or more software applications operating on the marine electronics device;
system performance history regarding the marine electronics device; or
a combination thereof.

16. The non-transitory computer-readable medium of claim 13, wherein the data collected at the marine electronics device describes one or more user activities monitored by the marine electronics device.

17. A non-transitory computer-readable medium having stored thereon a plurality of computer-executable instructions which, when executed by a computer, cause the computer to:
receive data at a marine electronics device from one or more peripheral devices in communication with the marine electronics device;
store the received data on the marine electronics device;
determine whether a network connection exists to a cloud server; and
when the network connection exists, send the stored data to the cloud server.

18. The non-transitory computer-readable medium of claim 17, wherein the computer-executable instructions that cause the computer to determine whether the network connection exists comprise computer-executable instructions which, when executed by the computer, cause the computer to determine whether a connection exists to the Internet.

19. The non-transitory computer-readable medium of claim 17, wherein the received data comprise telematics data transmitted over a National Marine Electronics Association (NMEA) communication protocol.

20. The non-transitory computer-readable medium of claim 17, wherein the one or more peripheral devices comprise:
a radar system;
a sonar system;
a propulsion system;
a global positioning system (GPS) device; or
a combination thereof.
